(19) United States
(12) Patent Application Publication
(10) Pub. No.: US 2009/0231950 A1
(43) Pub. Date: Sep. 17, 2009

(54) Apparatus for the thermal conditioning of concrete

(76) Inventor: Fabrizio Spagnolo, Massapequa, NY (US)

Correspondence Address: JAMES M. LOEFFLER, ESQ. PLLC, COURTHOUSE CORPORATE CENTER, 320 CARLETON AVENUE, SUITE 6800, CENTRAL ISLIP, NY, 11722, US

(21) Appl. No.: 12/075,433

(22) Filed: Mar. 11, 2008

(51) Int. Cl. B28C 5/46

(52) U.S. Cl. 366/25; 366/24

(57) ABSTRACT

An apparatus for thermally treating concrete during transportation in a concrete mixer truck which includes a unit mounted on the chassis of the concrete mixer truck for providing at least one of a cooling and heating medium; a heat exchanging radiator assembly mounted adjacent to a concrete mixing drum of the concrete mixer truck and configured to receive at least one of the cooling and heating medium from the unit; and a mixing water tank mounted on the concrete mixer truck.

### BACKGROUND OF THE INVENTION

1. Field of the Invention

The present invention relates to a system and apparatus for thermally treating ready mixed and/or transit mixed concrete, and, more specifically, to an apparatus for cooling or heating ready mixed and transit mixed concrete during transportation in a concrete mixer truck.

2. Description of the Background Art

Ready mixed and transit mixed concrete is a combination of fine aggregate (usually sand), coarse aggregate (usually crushed stone or gravel), cement, and water. Often chemical admixtures are added to modify aspects of the concrete design mix and or performance, such as viscosity, workability, or air content. Concrete is formed by mixing the components and allowing the mixture to harden.

The process of concrete hardening (or “setting” or “curing”) is a chemical reaction between the water and cement. This chemical reaction falls under a class of chemical reactions known as hydrolysis. A natural by-product of all hydrolysis reactions is heat. In the case of concrete curing, heat also acts to speed the rate of reaction, causing concrete to set more rapidly. The rate of setting is often in need of controlling in order to maintain desirable properties of the concrete, both in the plastic and cured states. These traits vary from workability, viscosity (called “slump”), and setting time in plastic concrete to concrete strength (measured in PSI or pounds per square inch) and durability in cured concrete. Standard concrete strengths range from 2000 PSI at an age of 28 days to 5000 PSI at 28 days. Higher and lower strengths are also available. The standard method of measuring concrete strength is to measure the strength of a test cylinder at 28 days of age from the date of concrete pouring and initial setting. This testing/measuring is done at regulated temperature and humidity conditions. Other tests are available and in use.

The American Concrete Institute (ACI) and the American Society for Testing and Materials (ASTM) are the two main academic bodies that set standards for concrete production and usage in the United States. ACI publishes the ACI Manual of Concrete Practice as a standard reference, which is revised annually. Several sections address the effects of temperature before, during and after the initial setting of the concrete. ASTM standards concentrate more on the specifications for the aggregates, water, and cement themselves, rather than with concrete.

As temperature has a direct effect on the rate at which concrete sets and the properties of plastic and cured concrete, controlling temperature becomes highly desirable. The temperature of concrete has direct effects upon setting time of concrete as well as strength development. The effects of various ambient and mix temperatures on concrete strength development are well studied and documented. While cooler and warmer mix temperatures affect strength at the standard 28 day interval when compared to a mix at 73° F., at 90 days and older, concrete strengthens to the desired design strength or very close to that mark, as far out as 365 days. ACI has sections devoted to both cold and hot weather concreting, as well as numerous subsections in various sections and chapters about concrete temperature in relation to other aspects of concrete work (such as time of transport or temperature effects on concrete in various stress conditions).

ACI 305 deals with hot weather concreting and ACI 306 deals with cold weather concreting. In order to achieve the desired concrete strength, the recommended range for the temperature of the concrete mix (at the time of concrete placement) in most applications is 40° F. through 90° F. However, the specifications for specific projects may have more stringent requirements for temperature of the concrete mix. In cases where concrete is being poured in hot weather, ACI 305 (2006 edition) has listed in Appendix B five methods for cooling concrete temperature. These include:

B1—Cooling with chilled mixing water: Using cooled water at the concrete plant as mixing water to help cool other ingredients of the concrete mix and have a lower starting temperature for the hydrolysis reaction,

B2—Liquid nitrogen cooling of mixing water: Using liquid nitrogen for the rapid cooling of water at the concrete batch plant for use in the concrete mix,

B3—Cooling water with ice: Using ice to replace up to 75% of the mixing water for the concrete mix,

B4—Cooling mixed concrete with liquid nitrogen: Using liquid nitrogen to directly cool the concrete mix either at the concrete plant or at the jobsite when concrete arrives,

B5—Cooling of coarse aggregates: Using various methods, such as spraying cooled water onto stockpiles of gravel, to cool the coarse aggregate prior to concrete batching and production.

All five of these methods are designed to be implemented either at the concrete batch plant prior to the mixer truck beginning the trip to the jobsite or at the jobsite after the mixer truck arrives.

However, a critical time for maintaining the concrete at a desirable temperature is during transportation to the jobsite. For instance, cooling during transportation is critical because it is a period of time wherein the concrete mix will begin producing heat from the hydrolysis reaction as well as absorbing ambient heat. Cooling also will have the added benefit of slowing the rate of hydrolysis down, effectively retarding concrete setting and extending the time in which concrete remains in a usable plastic state (aiding workability and slump). While ACI has no current method for cooling during the transportation period, ACI 304R-12 4.6 states:

Batch-to-batch uniformity of concrete from a mixer, particularly with regard to slump, water requirement, and air content, also depends on the uniformity of concrete temperature. Controlling the maximum and minimum concrete temperatures throughout all seasons of the year is important.

When the maximum temperature of the mix is regulated during transportation, an inspector will be less likely to reject an entire load of concrete when it arrives at the jobsite. Thus, a cost effective way of controlling temperatures during transport is highly desirable. Furthermore, the established methods for cooling concrete temperature all require highly specialized equipment with high investment, maintenance, and labor costs.

In the case of cold weather concreting, ACI 306 states that the minimum temperature of concrete at the time of placement is dependent upon the intended use of the concrete. However, ACI 306 also states that a minimum temperature at the time of placement is approximately 40° F. in the most accommodating application. With all cases of cold weather concreting, ACI has recommendations for the temperature of the concrete at the time of placement. This fact allows concrete producers to utilize the time available between loading concrete into mixers at the concrete plant and the time of placement on the jobsite to heat the concrete into the range of temperatures called for by specification. Currently, the most widely used method of warming concrete is to heat mixing water at the time of batching at the plant. Often, water is heated to near boiling point in order to aid in bringing overall concrete temperatures up.

The current invention is applicable without any adverse affects to any of the currently used methods of heating or cooling concrete. In fact, the present invention will supplement or eliminate the currently used methods. Effectively, the workload of those current, costly systems may be reduced by implementing the invention.

Accordingly, there is a need in the art for an apparatus that will effectively regulate the temperature of ready mixed and transit mixed concrete during transport thereof.

### SUMMARY OF THE INVENTION

It is an object of the present invention to provide a system and apparatus for thermally treating (heating or cooling) ready mixed and transit mixed concrete, and, more specifically, to a system and apparatus for thermally treating ready mixed and transit mixed concrete during transportation in mixer trucks. The proposed method is far less labor intensive and has the added benefit of acting upon the mix during the entire time of transport, a time period up until now that was not utilized to treat concrete or maintain temperatures (and thereby desirable qualities) of concrete.

The system and apparatus for cooling ready mixed and transit mixed concrete during transportation in a concrete mixer truck solves many of the problems in the prior art. For example, the present invention provides a cost effective and labor simplified system of cooling concrete. Cooling concrete will increase workability in warm weather conditions. Cooling concrete during transport will increase the life of concrete in a plastic state. There is no adverse long term effect on concrete due to initial high temperatures. The cooled concrete will meet standard specifications for concrete on project sites, thereby reducing lost costs.

In accordance with the objectives referred to herein, the present invention provides for an apparatus for thermally treating concrete during transportation in a concrete mixer truck which includes a unit mounted on the chassis of the concrete mixer truck for providing at least one of a cooling and heating medium; a heat exchanging radiator assembly mounted adjacent to a concrete mixing drum of the concrete mixer truck and configured to receive at least one of the cooling and heating medium from the unit; and a mixing water tank mounted on the concrete mixer truck. The at least one of the cooling and heating medium may also be routed through a coil in the mixing water tank after it passes through the heat exchanging radiator assembly. The cooling medium is preferably a liquid refrigerant and the heating medium is preferably a liquid solution including hot water. A fan unit may be positioned adjacent to the heat exchanging radiator assembly. Additional elongate radiators may be positioned along a lower portion of the concrete mixer drum. Also, a shell may be formed around the heat exchanging radiator assembly wherein the shell is formed of a plastic material having insulating qualities to at least partially shield the heat exchanging radiator assembly from ambient conditions. A set of brushes and a drain plug may be positioned at the upper and lower ends of the shell, respectively, to keep the area between the shell and concrete mixing drum free of debris and condensation.

The invention is not limited to the above-described embodiments, and various changes are possible without departing from the principles set forth herein. Furthermore, the embodiments include the invention at various stages, and various inventions can be extracted by properly combining multiple disclosed constructional requirements. There are many applications of this design.

The above is a brief description of some deficiencies in the prior art and advantages of the present invention. Other features, advantages and embodiments of the invention will be apparent to those skilled in the art from the following description, drawings.

### BRIEF DESCRIPTION OF THE DRAWINGS

The invention will become more clearly understood from the following detailed description in connection with the accompanying drawings, in which:

FIG. 1 is a side view illustrating a system and apparatus for thermally treating ready mixed and transit mixed concrete during transportation in a concrete mixer truck, in accordance with an embodiment of the present invention;

FIG. 2 is a top view illustrating a system and apparatus for thermally treating ready mixed and transit mixed concrete during transportation in a concrete mixer truck, in accordance with an embodiment of the present invention;

FIG. 3 is a side view illustrating a system and apparatus for cooling or heating ready mixed and transit mixed concrete during transportation in a concrete mixer truck, in accordance with an embodiment of the present invention;

FIG. 4 is a cross-section view illustrating the heat exchanging radiator assembly a system and apparatus for thermally treating ready mixed and transit mixed concrete during transportation in a concrete mixer truck, in accordance with an embodiment of the present invention;

FIG. 5 is a cross-section view of a mixer drum utilized with a system and apparatus for thermally treating ready mixed and transit mixed concrete during transportation in a concrete mixer truck, in accordance with an embodiment of the present invention; and

FIG. 6 is a cross-section view of a radiator assembly and mixer drum utilized with a system and apparatus for thermally treating ready mixed and transit mixed concrete during transportation in a concrete mixer truck, in accordance with an embodiment of the present invention.

### DETAILED DESCRIPTION OF THE PREFERRED EMBODIMENTS

The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

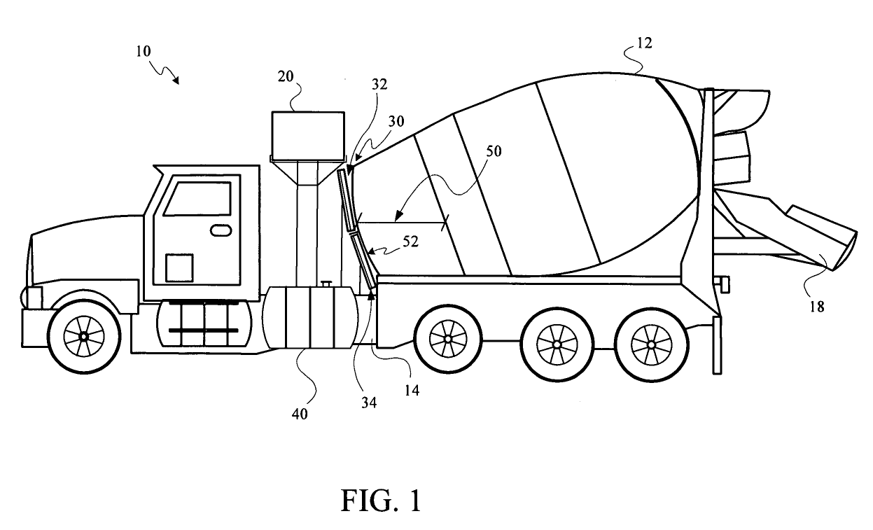

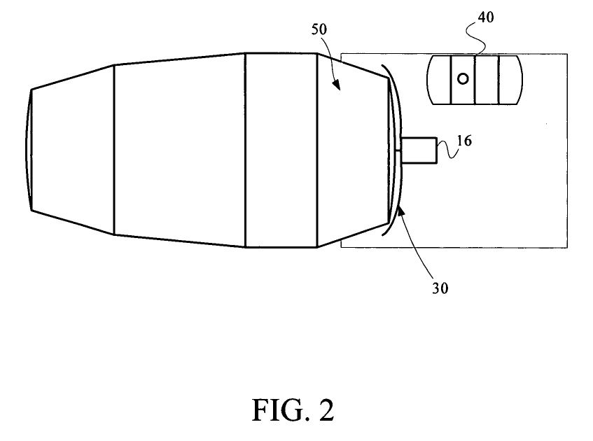

Referring now to the drawings in detail, and first to FIGS. 1-3, a conventional rotary mixer drum 12 is rotatably mounted on a chassis 14 of a mixer truck 10. A hydraulic motor 16 (best shown in FIGS. 2-4) is typically linked to a hydraulic pump (not shown) by hydraulic fluid carrying hoses (not shown), the pump being provided at a central location of the mixer truck. It is also contemplated that the pump may be any other type of pump suitable for the application and known to one having ordinary skill in the art. The hydraulic motor 16 maintains the mixer drum 12 in continuous rotary motion. Mixer truck drums are designed to allow for concrete to be mixed continuously during transport. The entire load of concrete is mixed by fins attached to the inside of the mixer drum 12 and arranged in a spiraled fashion. The fins pull concrete over the entire length of the drum 12 to provide for uniform mixing throughout the slurry. When the concrete mix is needed, it exits through the rear of the mixer drum 12 and down swing chute 18.

With continued reference to FIGS. 1-3, the system and apparatus for thermally treating ready mixed and transit mixed concrete during transportation in a concrete mixer truck 10 in accordance with the present invention generally includes a cooling/heating unit 20, a heat exchanging radiator assembly 30, and a mixing water tank 40.

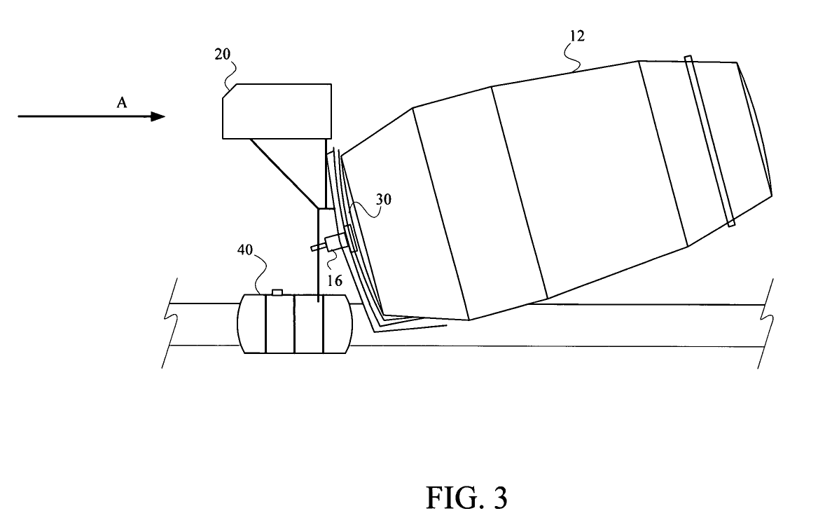

In accordance with the present invention, cooling/heating unit 20 includes and utilizes a compressor to compress a coolant material. Preferably, the compressor is a standard type compressor known to one having ordinary skill in the art (for example, the compressor may be of the type commonly found on refrigerated cargo trucks). The coolant material is preferably a commercially available refrigerant or coolant (for example, the coolant may be “Freon”). While the concrete mixer truck 10 is in transit, airflow in the direction indicated by arrow A in FIG. 3 is forced through cooling/heating unit 20.

Coolant which flows through the cooling/heating unit 20 is compressed and circulated to the heat exchanging radiator assembly 30. Heat exchanging radiator assembly 30 preferably includes an upper heat exchanging radiator section 32 and a lower heat exchanging radiator section 34. Heat exchanging radiator assembly 30 is preferably configured as a series of pie wedge shaped radiator style heat exchangers. In order to prevent concrete from falling out of the mixer drum 12 while truck 10 is in transit, the mixer drum 12 is configured and positioned such that the concrete mix is directed to a location in the drum 12 which is away from the exit location toward a first section 50 of the mixer drum 12. An end of the first section 50 of the mixer drum 12 is referred to herein as the head portion 52. Preferably, the heat exchanging radiator assembly 30 is positioned adjacent to the head portion 52 of the mixer truck's drum 12, since it is this section which will be in continuous contact with the concrete mix during transit. The heat exchanging radiator assembly 30 is preferably placed as close as possible to the outer surface of the rotating mixer drum 12. Typically, the outer surface of the rotating mixer drum is constructed of steel.

Once the coolant is circulated through the heat exchanging radiator assembly 30, the coolant is circulated back to the compressor within cooling/heating unit 20. Alternatively, the coolant is first routed through the mixing water tank 40 via a coil passing through the tank 40. Thus, the coolant will also cool or heat the water within the mixing water tank 40. The water contained in mixing water tank 40 is utilized for mixing with the concrete mix as necessary. Therefore, the result of the cooling or heating of the water within mixing water tank 40 will enhance the objective of this invention. As illustrated, the mixing water tank 40 is typically placed on the driver's side of the truck. However, it is contemplated that placement of the mixing water tank 40 may vary as design constraints vary.

Alternatively, during cold weather applications, cooling/heating unit will circulate hot fluid through the heat exchanging radiator assembly 30. The hot fluid may be, for example, a solution of water and anti-freeze. The fluid may be heated by a means know to one having ordinary skill in the art, including, but not limited to, a gas heater, an electric heater or routing the fluid through the concrete mixing truck's engine cooling system.

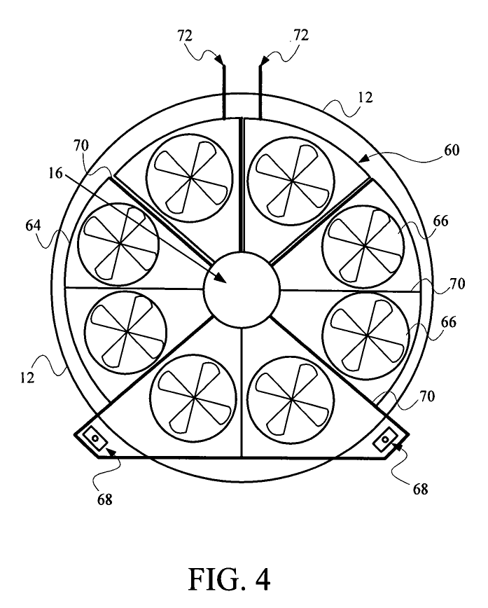

Referring now to FIG. 4, there is shown a cross-sectional view of a heat exchanging radiator assembly 60 for use with a system and apparatus for cooling/heating ready mixed and transit mixed concrete during transportation in a concrete mixer truck 10, in accordance with another embodiment of the present invention. As illustrated, the heat exchanging radiator assembly 60 includes eight pie wedge shaped radiators 64 with each individual radiator containing its own fan unit 66. It is contemplated that there may be more or less individual radiators 64 and that the individual radiators 64 may be of any geometrical shape and/or configuration. The eight radiators 64 may be mounted on support bars 70 adjacent to the head of mixer drum 12. It is also contemplated that any number of fan units 66 may be utilized or that no fan units may be utilized. The fan units are preferably connected to a control system based on the temperature of the coolant, as is known to one having ordinary skill in the art. It is also contemplated that a control system for circulating the coolant and turning the fans on and off is part of the present invention. Such control system may be housed separately or may be contained within a housing for the cooling/heating unit 20.

It is also contemplated that two elongate radiators 68 are positioned along the lower portion of mixer drum 12 to provide additional cooling/heating to the bottom of mixer drum 12, since it is the bottom portion of the mixer drum 12 that will be in continuous contact with the concrete mix contained therein. Preferably, the two elongate radiators 68 extend longitudinally along the lower portion of mixer drum 12. It is contemplated that any number of elongate radiators may be employed and, although the bottom portion of the drum may be the most convenient location, it is also contemplated that any number of elongate radiators may be placed at various locations around the circumference of mixer drum 12.

At the top of the radiator assembly 60, illustrated in FIG. 4, two lines 72 are shown. The two lines 72 represent the coil or conduit for transporting the coolant from the cooling/heating unit 20 (shown in FIG. 1) in and out of the heat exchanging radiator assembly 60. The two lines 72 may be formed of any suitable material known to one having ordinary skill in the art.

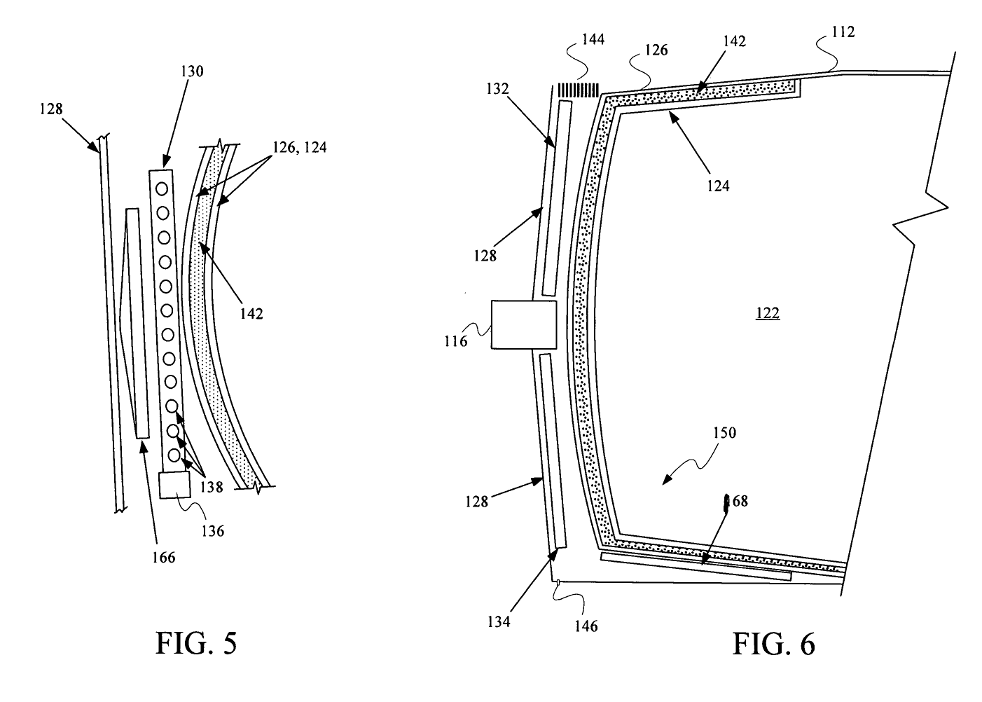

Referring now to FIGS. 5 and 6, there is illustrated a cross-section view of a radiator assembly and mixer drum utilized with a system and apparatus for cooling/heating ready mixed and transit mixed concrete during transportation in a concrete mixer truck, in accordance with an embodiment of the present invention.

In the embodiment illustrated in FIGS. 5 and 6, the first section 150 of mixer drum 112 head has an inner wall surface 124 and an outer wall surface 126. The inner wall surface 124 and outer wall surface 126 define a void in between the two walls. The void defined between inner wall surface 124 and outer wall surface 126 is preferably filled with a coolant gas or liquid 142. The coolant gas or liquid 142 absorbs heat generated in the inside or outside area 122 of mixing drum 112 which is transferred through inner wall surface 124. That heat is then transferred from the coolant gas or liquid 142 to the outer wall surface 126. The heat is ultimately removed (or added) from the outer wall surface 126 by the air traveling through the heat exchanging radiator assembly 130, which, in turn, is cooled or heated by the circulating coolant which flows from the cooling/heating unit 20 (see FIGS. 1 and 2).

Various configurations of cooling radiator assembly 130 are contemplated for use with the present invention. For example, in FIG. 5, cooling radiator assembly includes a single unit 130 which may be supported off of the truck chassis by support bracket 136. Cooling radiator assembly 130 includes a plurality of tubes 138. Tubes 138 provide the conduit for circulating the coolant from the cooling unit. Alternatively, in FIG. 6, cooling radiator assembly 130 includes an upper cooling radiator section 132 and a lower radiator section 134. Each of the upper cooling radiator section 132 and the lower radiator section 134 may comprise a plurality of separate wedge-shaped radiator sections. Additionally, an additional elongated radiator 168 may be installed, preferably longitudinally along the bottom portion of the mixer drum 120 to provide additional cooling.

As best seen in FIG. 5, a fan unit 166 is provided adjacent to cooling radiator assembly 130. The fan unit 166 is provided to force air through the cooling radiator assembly 130 and onto the outer surface 126. The air which is forced through cooling radiator assembly 130 is cooled by the coolant which flows through tubes 138 within the cooling radiator assembly 130. The cooled air then comes in contact with the outer surface 126 of the mixer drum 112, thereby removing heat from outer surface 126. As heat is removed from outer surface 126, outer surface 126, in turn, removes heat from the coolant 142. The coolant 142 is in contact with inner surface 124 of the mixer drum 112 and absorbs heat from the inner surface 124. The heat that is transferred through inner surface 124, coolant 142, and outer surface 126 is generated by the chemical process taking place within the mixer drum 112. As the load of concrete is mixed within the mixer drum 112, the concrete will come in contact with the cooled area of the drum thereby facilitating rapid transfer of heat across the system.

This process would allow the entire load of concrete to come into contact with the treated areas of the drum. The high density of concrete, particularly the aggregates, and the liquid nature of freshly mixed concrete will facilitate rapid transfer of heat across the system. As illustrated in FIGS. 5 and 6, a shell 128 is formed around the cooling radiator assembly 130. In a preferred embodiment, the shell 128 is formed of a plastic or composite material and has insulating qualities to keep the hot ambient conditions off of the cooling radiator assembly 130. A set of debris brushes 144 are provided at an upper end of the shell 128, to prevent debris from falling between the shell 128 and the mixer drum 112. A drain plug 146 is provided in the lower portion of the shell 128 to remove condensation that collects in the inside of the shell 128.

Although the present invention has been described in accordance with the embodiments shown, one of ordinary skill in the art will readily recognize that there could be variations to the embodiment and these variations would be within the spirit and scope of the present invention. For example, the size of the mixer drum, as well as local climate conditions, may affect the size and/or power requirements of the compressor unit and other components of the system and apparatus for thermally treating ready mixed and transit mixed concrete during transportation in a concrete mixer truck. Also, the system and apparatus may be powered by dedicated engines, dedicated batteries or the systems that provide power to the truck. When the need to cool or heat concrete is not required, whether by project specification, distance of transportation, or season of the year, the unit can just be powered down. The mixer truck can remain in operation, not taking up space or staying unproductive for the concrete supplier. Furthermore, it is contemplated that the present invention may be configured to be utilized in each of the two main types of mixer trucks, front discharge and rear discharge.

Although the present invention has been described in accordance with the embodiments shown, one of ordinary skill in the art will readily recognize that there could be variations to the embodiment and these variations would be within the spirit and scope of the present invention. Accordingly, many modifications may be made by one of ordinary skill in the art without departing from the spirit and scope of the invention.

What is claimed is:

1. An apparatus for thermally treating concrete during transportation in a concrete mixer truck comprising:
a unit mounted on a concrete mixer truck for providing at least one of a cooling and heating medium;
a heat exchanging radiator assembly mounted adjacent to a concrete mixing drum of the concrete mixer truck and configured to receive at least one of the cooling and heating medium from the unit; and
a mixing water tank mounted on the concrete mixer truck.

2. The apparatus for thermally treating concrete during transportation in a concrete mixer truck as recited in claim 1 wherein the unit is mounted on the chassis of the concrete mixer truck.

3. The apparatus for thermally treating concrete during transportation in a concrete mixer truck as recited in claim 1 wherein the at least one of the cooling and heating medium is routed through a coil in the mixing water tank.

4. The apparatus for thermally treating concrete during transportation in a concrete mixer truck as recited in claim 1 wherein the heat exchanging radiator assembly comprises an upper heat exchanging radiator section and a lower heat exchanging radiator section.

5. The apparatus for thermally treating concrete during transportation in a concrete mixer truck as recited in claim 1 wherein the heat exchanging radiator assembly comprises a series of pie wedge shaped radiator style heat exchangers.

6. The apparatus for thermally treating concrete during transportation in a concrete mixer truck as recited in claim 5 further comprising a fan unit positioned adjacent each of the pie wedge shaped radiator style heat exchangers.

7. The apparatus for thermally treating concrete during transportation in a concrete mixer truck as recited in claim 1 wherein the heat exchanging radiator assembly is positioned adjacent to a head portion a drum on the concrete mixer truck.

8. The apparatus for thermally treating concrete during transportation in a concrete mixer truck as recited in claim 1 wherein the cooling medium is a liquid refrigerant.

9. The apparatus for thermally treating concrete during transportation in a concrete mixer truck as recited in claim 1 wherein the heating medium is a hot fluid.

10. The apparatus for thermally treating concrete during transportation in a concrete mixer truck as recited in claim 1 further comprising two elongate radiators positioned along a lower portion of the concrete mixer drum.

11. The apparatus for thermally treating concrete during transportation in a concrete mixer truck as recited in claim 1 further comprising a fan unit configured to force air through the heat exchanging radiator assembly and onto an outer surface of the concrete mixer drum.

12. The apparatus for thermally treating concrete during transportation in a concrete mixer truck as recited in claim 1 further comprising a shell formed around the heat exchanging radiator assembly.

13. The apparatus for thermally treating concrete during transportation in a concrete mixer truck as recited in claim 12 wherein the shell is formed of a plastic material having insulating qualities to at least partially shield the heat exchanging radiator assembly from ambient conditions.

14. The apparatus for thermally treating concrete during transportation in a concrete mixer truck as recited in claim 12 further comprising a set of brushes positioned at an upper end of the shell to prevent debris from falling between the shell and the concrete mixing drum.

15. The apparatus for thermally treating concrete during transportation in a concrete mixer truck as recited in claim 12 further comprising a drain plug positioned at a lower end of the shell to facilitate removal of condensation that may collect between the shell and the concrete mixing drum.

16. An apparatus for thermally treating concrete during transportation in a concrete mixer truck comprising:
a unit mounted on a concrete mixer truck for providing at least one of a cooling and heating medium; and
a heat exchanging radiator assembly mounted adjacent to a concrete mixing drum of the concrete mixer truck and configured to receive at least one of the cooling and heating medium from the unit.

17. An apparatus for thermally treating concrete during transportation in a concrete mixer truck as recited in claim 16 further comprising a mixing water tank mounted on the concrete mixer truck.

18. The apparatus for thermally treating concrete during transportation in a concrete mixer truck as recited in claim 16 wherein the heat exchanging radiator assembly is positioned adjacent to a head portion a drum on the concrete mixer truck.

19. The apparatus for thermally treating concrete during transportation in a concrete mixer truck as recited in claim 16 further comprising two elongate radiators positioned along a lower portion of the concrete mixer drum.

20. The apparatus for thermally treating concrete during transportation in a concrete mixer truck as recited in claim 16 further comprising a fan unit configured to force air through the heat exchanging radiator assembly and onto an outer surface of the concrete mixer drum.
